(19) United States
(12) Patent Application Publication
(10) Pub. No.: US 2012/0173599 A1
(43) Pub. Date: Jul. 5, 2012

(54) SYSTEM AND METHOD FOR GENERATING TRUE RANDOM NUMBERS USING COMPUTING DEVICE

(75) Inventor: FENG GAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/204,721

(22) Filed: Aug. 8, 2011

(30) Foreign Application Priority Data
Dec. 29, 2010 (CN) 201010612876.3

(51) Int. Cl. G06F 7/58

(52) U.S. Cl. 708/254

(57) ABSTRACT

In a system and method for generating true random numbers, a computing device initializes a data storage area in a memory as a buffer, and obtains random events generated by the computing device. The system converts each of the random events to a random data represented by a series of binary digits, and stores the binary digits of the random data to a data array. The binary digits of each of the data arrays are mixed into the buffer to generate a random number source. The system further retrieves a random number sequence from the random number source stored in the buffer, and generates a true random number according to the random number sequence.

### BACKGROUND

1. Technical Field

Embodiments of the present disclosure relate to random number systems and methods, and particularly to a system and a method for generating true random numbers using a computing device.

2. Description of Related Art

There are many applications that require the fast production of random numbers having high levels of randomness. Such applications include cryptographic key generation in key servers, session keys, and simulations. Most random numbers used in computer programs are pseudo-random, which means they are a generated in a predictable fashion using a mathematical formula. A random number generator is a computational or physical device designed to generate a sequence of numbers or symbols that lack any pattern, i.e., pseudo-random numbers. Computer-based systems for random number generation are widely used, but they may meet some statistical tests for randomness intended to ensure that they do not have any easily discernible patterns. Thus, there is an ongoing need for systems and methods for efficiently generating true random numbers.

### BRIEF DESCRIPTION OF THE DRAWINGS

FIG. 1 is a block diagram of one embodiment of a computing device including a true random number generation system.

FIG. 2 is a flowchart of one embodiment of a method for generating true random numbers using the system of FIG. 1.

FIG. 3 is a schematic diagram illustrating one example of generating true random numbers using the computing device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

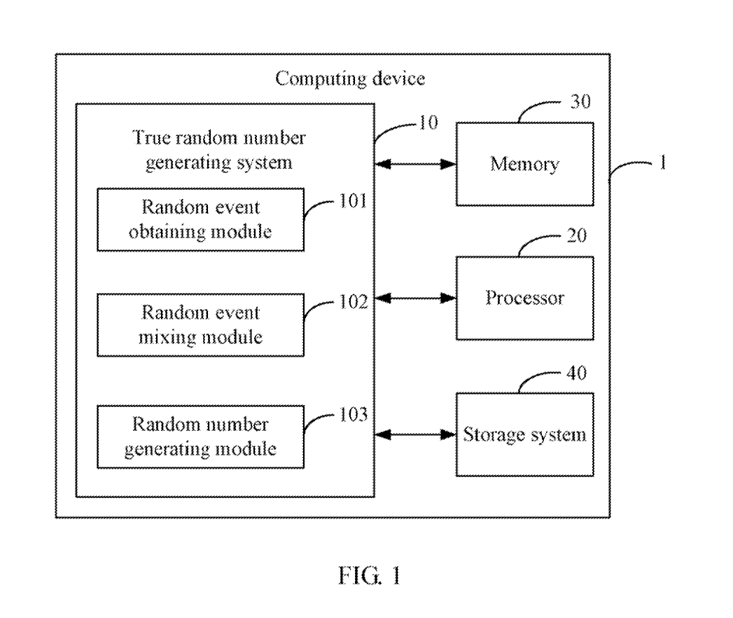

FIG. 1 is a block diagram of one embodiment of a computing device 1 including a true random number generation system 10. In the embodiment, the computing device 1 may include at least one processor 20, a memory 30, and a storage system 40. It should be understood that FIG. 1 illustrates only one example of the computing device 1 that may include more or fewer components than illustrated, or a different configuration of the various components in other embodiments.

In the embodiment, the system 10 can obtain a plurality of random events generated by the computing device 1, and generate one or more random numbers according to the random events. It is understood that the random numbers may include a true random number and a pseudo random number. The true random number is defined as a random number that has a high level of randomness and being unpredictable. On the contrary, the pseudo random number is defined as a random number that has lesser level of randomness, and can be predictable and reproduced easily. The random events include, but are not limited to, an ASCII code of an input key, a system time, a fan speed, a CPU interruption event, a data sending event, and a data receiving event.

The system 10 comprises computerized instructions in the form of one or more programs that are executed by the at least one processor 20, and stored in the storage system 40 of the computing device 1. In one embodiment, the storage system 40 may be an internal storage system, such as a random access memory (RAM) for temporary storage of information, and/or a read only memory (ROM) for permanent storage of information. In some embodiments, the storage system 12 may also be an external storage system, such as an external hard disk, a storage card, or a data storage medium.

In one embodiment, the system 10 includes a random event obtaining module 101, a random event mixing module 102, and a random number generating module 103. The modules 101-103 may comprise computerized code in the form of one or more programs that are stored in the storage system 40 and executed by the processor 20 to provide functions for implementing the modules. In general, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

The random event obtaining module 101 is operable to initialize a data storage area in the memory 30 as a buffer. In the embodiment, the buffer may have 128 bits data storage space of the memory 20, and is used to store a random number source generated by the computing device 1. In one embodiment, the random number source is consisted of binary digits, such as a digital number “0” and a digital number “1”.

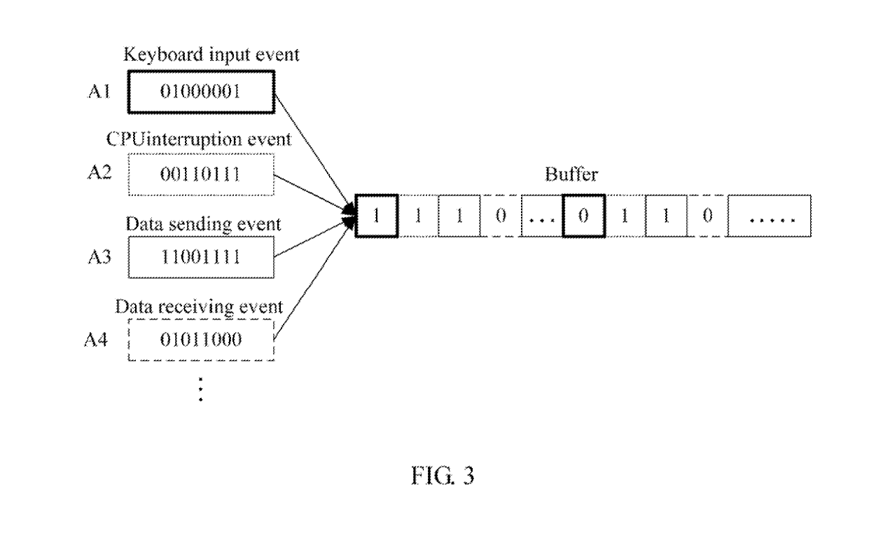

The random event obtaining module 101 is further operable to obtain a plurality of random events generated by the computing device 1, and convert each of the random events into a random data that is represented by a series of binary digits. During the operation process of the computing device 1, the random events may include a keyboard input event (e.g., receiving an ASCII code of an input key), a CPU interruption event, a data sending event and a data receiving event. In one example with respect to FIG. 3, the keyboard input event may be converted into a first random data that is represented by a series of binary digits “01000001”. The CPU interruption event may be converted into a second random data that is represented by a series of binary digits “00110111”. The data sending event may be converted into a third random data that is represented by a series of binary digits “11001111”. The data receiving event may be converted into a fourth random data that is represented by a series of binary digits “01011000”.

The random event mixing module 102 is operable to allocate a data array for each of the random data, and store the binary digits of the random data into the data array. Referring to FIG. 3, the first random data having the binary digits “01000001” is stored in the data array A1, the second random data having the binary digits “00110111” is stored in the data array A2, the third random data having the binary digits “11001111” is stored in the data array A3, and the fourth random data having the binary digits“01011000” is stored in the data array A4.

The random event mixing module 102 is further operable to mix the binary digits of each of the data arrays into the buffer, and generate a random number source according to the mixed binary digits. In one embodiment, the random event mixing module 102 may shift each of the binary digits from the data arrays into the buffer using a right shift operation or a left shift operation. In one example with respect to FIG. 3, the top right digit “1” of the first data array A1 is firstly shifted into the buffer, the top right digit “1” of the second data array A2 is secondly shifted into the buffer, the top right digit “1” of the third data array A3 is thirdly shifted into the buffer, and the top right digit “0” of the forth data array A4 is finally shifted into the buffer. After the binary digits of all the data arrays are shifted into the buffer, the random number sequence “1110 . . . 0110 . . . ” may be generated and stored as the random number source.

The random event mixing module 102 is further operable to determine whether the random number source needs to be updated. In one embodiment, the random event mixing module 102 determines that the random number source needs to be updated when an update command is input from the computing device 1, then the random event obtaining module 101 obtains other random events from the computing device 1 to generate a new random number source.

The random number generating module 103 is operable to retrieve a random number sequence from the random number source stored in the buffer, generate a true random number according to the random number sequence, and display the true random number on a display screen of the computing device 1. For example, the random number generating module 103 retrieves a random number sequence “11100110” from the random number source “11100110 . . . 0110 . . . ”, and then converts the random number sequence “11100110” into a decimal number “230” as the true random number.

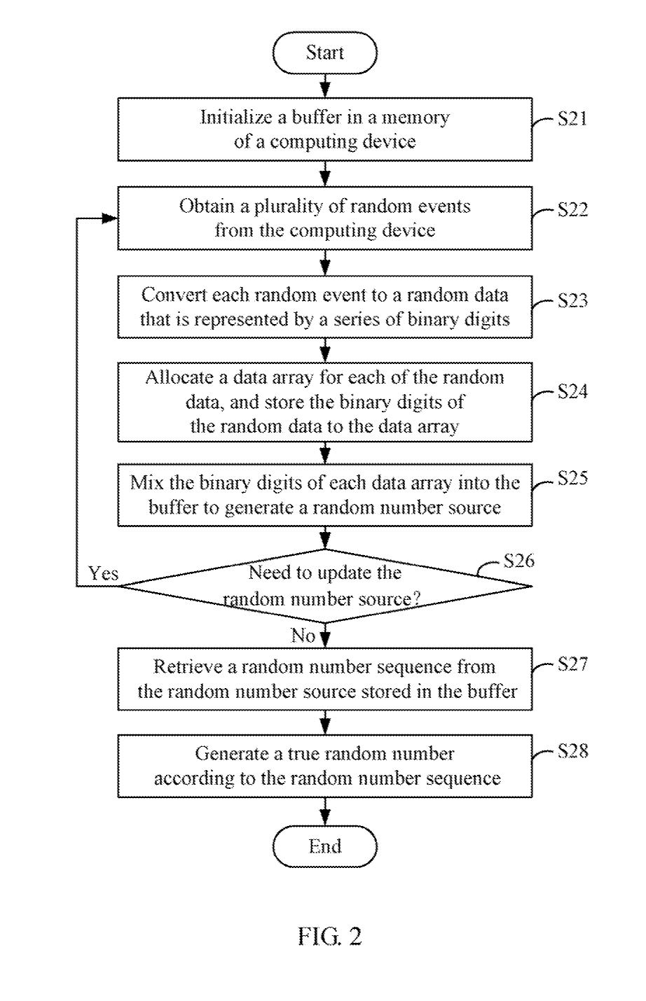

FIG. 2 is a flowchart of one embodiment of a method for generating true random numbers using the system 10 of FIG. 1. In the embodiment, the method can obtain a plurality of random events generated by the computing device 1, and generates one or more true random numbers according to the random events. Depending on the embodiment, additional blocks may be added, others removed, and the ordering of the blocks may be changed.

In block S21, the random event obtaining module 101 initializes a data storage area in the memory 30 as a buffer. In the embodiment, the buffer may have 128 bits data storage space of the memory 20, and is used to store a random number source generated by the computing device 1. The random number source consists of binary digits, such as a digital number “0” and a digital number “1”.

In block S22, the random event obtaining module 101 obtains a plurality of random events generated by the computing device 1. During the operation process of the computing device 1, the computing device 1 may generate one or more random events that may include, but are limited to, a keyboard input event (e.g., receiving an ASCII code of an input key), a CPU interruption event, a data sending event and a data receiving event.

In block S23, the random event obtaining module 101 converts each of the random events to a random data that is represented by a series of binary digits. In one example with respect to FIG. 3, the keyboard input event may be converted into a first random data that is represented by a series of binary digits “01000001”. The CPU interruption event may be converted into a second random data that is represented by a series of binary digits “00110111”. The data sending event may be converted into a third random data that is represented by a series of binary digits “11001111”. The data receiving event may be converted into a fourth random data that is represented by a series of binary digits “01011000”.

In block S24, the random event mixing module 102 allocates a data array for each of the random data, and store the binary digits of the random data to the data array. Referring to FIG. 3, the first random data having the binary digits “01000001” is stored in the data array A1, the second random data having the binary digits “00110111” is stored in the data array A2, the third random data having the binary digits “11001111” is stored in the data array A3, and the forth random data having the binary digits “01011000” is stored in the data array A4.

In block S25, the random event mixing module 102 mixes the binary digits of each of the data arrays into the buffer, and generates a random number source according to the mixed binary digits. In one embodiment, the random event mixing module 102 may shift each of the binary digits from the data arrays into the buffer using a right shift operation or a left shift operation. In one example with respect to FIG. 3, the top right digit “1” of the first data array A1 is firstly shifted into the buffer, the top right digit “1” of the second data array A2 is secondly shifted into the buffer, the top right digit “1” of the third data array A3 is thirdly shifted into the buffer, and the top right digit “0” of the forth data array A4 is finally shifted into the buffer. After the binary digits of all the data arrays are shifted into the buffer, the random sequence “1110 . . . 0110 . . . ” may be generated and stored as the random number source.

In block S26, the random event mixing module 102 determines whether the random number source needs to be updated. In one embodiment, the random event mixing module 102 determines that the random number source needs to be updated when an update command is input from the computing device 1. If the random number source does not need to be updated, block S27 is implemented. Otherwise, if the random number source needs to be updated, block S22 is repeated to generate a new random number source.

In block S27, the random number generating module 103 retrieves a random number sequence from the random number source stored in the buffer. For example, the random number generating module 103 retrieves a random number sequence “11100110” from the random number source “11100110 . . . 0110 . . . ”.

In block S28, the random number generating module 103 generates a true random number according to the random number sequence, and displays the true random number on a display screen of the computing device 1. In the embodiment, the random number generating module 103 converts the random number sequence “11100110” into a decimal number “230” as the true random number.

All of the processes described above may be embodied in, and fully automated via, functional code modules executed by one or more general purpose processors of the computing devices. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

Although certain disclosed embodiments of the present disclosure have been specifically described, the present disclosure is not to be construed as being limited thereto.

Various changes or modifications may be made to the present disclosure without departing from the scope and spirit of the present disclosure.

What is claimed is:

1. A computing device, comprising:
a storage system;
at least one processor; and
one or more programs stored in the storage system and executable by the at least one processor, the one or more programs comprising:
a random event obtaining module operable to initialize a buffer in a memory of the computing device, obtain a plurality of random events generated by the computing device, and convert each of the random events into a random data that is represented by a serial of binary digits;
a random event mixing module operable to allocate a data array for each of the random data, store the binary digits of the random data to the data array, mix the binary digits of each of the data arrays into the buffer, and generate a random number source according to the mixed binary digits; and
a random number generating module operable to retrieve a random number sequence from the random number source stored in the buffer, and generate a true random number according to the random number sequence.

2. The computing device according to claim 1, wherein the random event mixing module mixes the binary digits of each of the data arrays into the buffer by shifting each of the binary digits from the data array into the buffer using a right shift operation or a left shift operation.

3. The computing device according to claim 1, wherein the random event mixing module is further operable to determine whether the random number source needs to be updated according to an update command input from the computing device.

4. The computing device according to claim 1, wherein the random number generating module is further operable to display the true random number on a display screen of the computing device.

5. The computing device according to claim 1, wherein the random events comprise an ASCII code of an input key, a system time, a fan speed, a CPU interruption event, a data sending event, and a data receiving event.

6. A computerized method for generating true random numbers using a computing device, the method comprising:
(a) initializing a buffer in a memory of the computing device;
(b) obtaining a plurality of random events generated by the computing device;
(c) converting each of the random events to a random data that is represented by a series of binary digits;
(d) allocating a data array for each of the random data, and storing the binary digits of the random data to the data array;
(e) mixing the binary digits of each of the data arrays into the buffer, and generating a random number source according to the mixed binary digits;
(f) retrieving a random number sequence from the random number source stored in the buffer; and
(g) generating a true random number according to the random number sequence.

7. The method according to claim 6, wherein the binary digits of each of the data arrays are mixed by shifting each of the binary digits from the data array into the buffer using a right shift operation or a left shift operation.

8. The method according to claim 6, further comprising:
determining whether the random number source needs to be updated according to an update command input from the computing device; and
repeating from the sep (b) to the step (e) if the random number source needs to be updated.

9. The method according to claim 6, further comprising:
displaying the true random number on a display screen of the computing device.

10. The method according to claim 6, wherein the random events comprise an ASCII code of an input key, a system time, a fan speed, a CPU interruption event, a data sending event, and a data receiving event.

11. A non-transitory computer-readable medium having stored thereon instructions that, when executed by at least one processor of a computing device, cause the computing device to perform a method for generating true random numbers, the method comprising:
(a) initializing a buffer in a memory of the computing device;
(b) obtaining a plurality of random events generated by the computing device;
(c) converting each of the random events to a random data that is represented by a series of binary digits;
(d) allocating a data array for each of the random data, and storing the binary digits of the random data to the data array;
(e) mixing the binary digits of each of the data arrays into the buffer, and generating a random number source according to the mixed binary digits;
(f) retrieving a random number sequence from the random number source stored in the buffer; and
(g) generating a true random number according to the random number sequence.

12. The non-transitory computer-readable medium according to claim 11, wherein the binary digits of each of the data arrays are mixed by shifting each of the binary digits from the data array into the buffer using a right shift operation or a left shift operation.

13. The non-transitory computer-readable medium according to claim 11, wherein the method further comprises:
determining whether the random number source needs to be updated according to an update command input from the computing device; and
repeating from the sep (b) to the step (e) if the random number source needs to be updated.

14. The non-transitory computer-readable medium according to claim 11, wherein the method further comprises:
displaying the true random number on a display screen of the computing device.

15. The non-transitory computer-readable medium according to claim 11, wherein the random events comprise an ASCII code of an input key, a system time, a fan speed, a CPU interruption event, a data sending event, and a data receiving event.
